(19) United States
(12) Patent Application Publication
(10) Pub. No.: US 2013/0342434 A1
(43) Pub. Date: Dec. 26, 2013

(54) LIQUID CRYSTAL DISPLAY DEVICE CAPABLE OF REDUCING RESIDUAL IMAGES AND RELATED METHOD THEREOF

(71) Applicants: Chien-Chou Chen, New Taipei City (TW); Yu-Nan Huang, New Taipei City (TW)

(72) Inventors: Chien-Chou Chen, New Taipei City (TW); Yu-Nan Huang, New Taipei City (TW)

(21) Appl. No.: 13/607,782

(22) Filed: Sep. 9, 2012

(30) Foreign Application Priority Data
Jun. 26, 2012 (TW) 101122784

(51) Int. Cl. G09G 3/36

(52) U.S. Cl. 345/102

(57) ABSTRACT

A method of reducing residual images of a liquid crystal display device includes generating multiple pulse width modulation signals corresponding to display blocks of a liquid crystal panel in turn; generating multiple driving signals corresponding to the display blocks according to the pulse width modulation signals; and correspondingly providing backlight to the display blocks according to the driving signals. During each frame period of the liquid crystal panel, each pulse width modulation signal has a first fixed width pulse voltage and a second fixed width pulse voltage. A period between a beginning of the first fixed width pulse voltage and an end of the second fixed width pulse voltage is longer than or equal to 16 milliseconds minus a predetermined time. A period between the end and a beginning of a first fixed width pulse voltage of a next frame period is shorter than or equal to the predetermined time.

### BACKGROUND OF THE INVENTION

1. Field of the Invention

The present invention relates to a liquid crystal display device and a related method thereof, and particularly to a liquid crystal display device and a related method thereof that can reduce residual images of a liquid crystal panel.

2. Description of the Prior Art

A traditional liquid crystal display usually suffers a problem of an unsatisfactory liquid crystal response rate, so that when the traditional liquid crystal display displays dynamic frames, liquid crystal molecules in a liquid crystal panel can not be rotated to a predetermined angle in time, resulting in images displayed on the liquid crystal panel being vague. The prior art disclosed in U.S. Patent Publication No. US 2009/0295706 discloses that a method of controlling backlight timing is utilized to improve vague images displayed on a liquid crystal panel, that is, a backlight module is turned off before liquid crystal molecules in the liquid crystal panel are rotated to a predetermined angle, and the backlight module is turned on after the liquid crystal molecules in the liquid crystal panel are rotated to the predetermined angle. However, reducing a turning-on period of the backlight module easily makes a user perceive flickers on the liquid crystal panel, which makes the user feel uncomfortable.

To solve the above mentioned problem, the prior art disclosed in U.S. Patent Publication No. US 2009/0295706 further discloses that the backlight module is driven twice during a frame period. Although driving the backlight module twice during a frame period can reduce flickers on the liquid crystal panel, it may cause residual images shown on the liquid crystal panel. Moreover, driving the backlight module twice during a frame period may further result in insufficient brightness of the liquid crystal panel. Therefore, how to simultaneously solve the above mentioned problems is an important issue.

### SUMMARY OF THE INVENTION

An embodiment of the present disclosure provides a liquid crystal display device capable of reducing residual images. The liquid crystal display device includes a liquid crystal panel, a pulse width modulation signal generator, a backlight driving circuit, and a backlight module. The liquid crystal panel has a 60 Hz frame rate, and the liquid crystal panel includes multiple display blocks. The pulse width modulation signal generator is used for generating multiple pulse width modulation signals corresponding to the display blocks in turn, wherein each pulse width modulation signal has a first fixed width pulse voltage and a second fixed width pulse voltage during each frame period of the liquid crystal panel, a period between a beginning of the first fixed width pulse voltage and an end of the second fixed width pulse voltage is longer than or equal to 16 milliseconds minus a predetermined time, wherein a period between the end of the second fixed width pulse voltage and a beginning of a first fixed width pulse voltage of a next frame period is shorter than or equal to the predetermined time. The backlight driving circuit is used for generating multiple driving signals corresponding to the display blocks according to the pulse width modulation signals. The backlight module is used for correspondingly providing backlight to the display blocks according to the driving signals.

The present disclosure provides a method of reducing residual images of a liquid crystal display device, the liquid crystal display device includes a pulse width modulation signal generator, a backlight driving circuit, a backlight module, and a liquid crystal panel, where the liquid crystal panel has a 60 Hz frame rate, and the liquid crystal panel includes multiple display blocks. The method includes the pulse width modulation signal generator generating multiple pulse width modulation signals corresponding to the multiple display blocks in turn, wherein each pulse width modulation signal has a first fixed width pulse voltage and a second fixed width pulse voltage during each frame period of the liquid crystal panel, a period between a beginning of the first fixed width pulse voltage and an end of the second fixed width pulse voltage is longer than or equal to 16 milliseconds minus a predetermined time, wherein a period between the end of the second fixed width pulse voltage and a beginning of a first fixed width pulse voltage of a next frame period is shorter than or equal to the predetermined time; the backlight driving circuit generating multiple driving signals corresponding to the display blocks according to the pulse width modulation signals; and the backlight module correspondingly providing backlight to the display blocks according to the driving signals.

The present disclosure provides a liquid crystal display device capable of reducing residual images and a method of reducing residual images of a liquid crystal display device. The liquid crystal display device and the method utilize a pulse width modulation signal generator to generate multiple pulse width modulation signals corresponding to multiple display blocks of the liquid crystal panel, where a liquid crystal relative steady-state region of the liquid crystal panel defined by each pulse width modulation signal between two consecutive vertical synchronous signals of the liquid crystal panel is longer than or equal to 16 milliseconds minus a predetermined time. Therefore, compared to the prior arts, the present disclosure not only can solve the problem of flickers on the liquid crystal panel and avoid reducing backlight illumination, but also can have lower manufacture cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a liquid crystal display device capable of reducing residual images according to an embodiment of the present disclosure.

FIG. 2 is a diagram illustrating a vertical synchronization signal of the liquid crystal panel, a liquid crystal state of the display block, and the pulse width modulation signal.

FIG. 3, FIG. 4, and FIG. 5 are diagrams illustrating adjustable width pulse voltages according to different embodiments.

FIG. 6 is a flowchart illustrating a method of reducing residual images of a liquid crystal display device according to another embodiment of the present disclosure.

### DETAILED DESCRIPTION

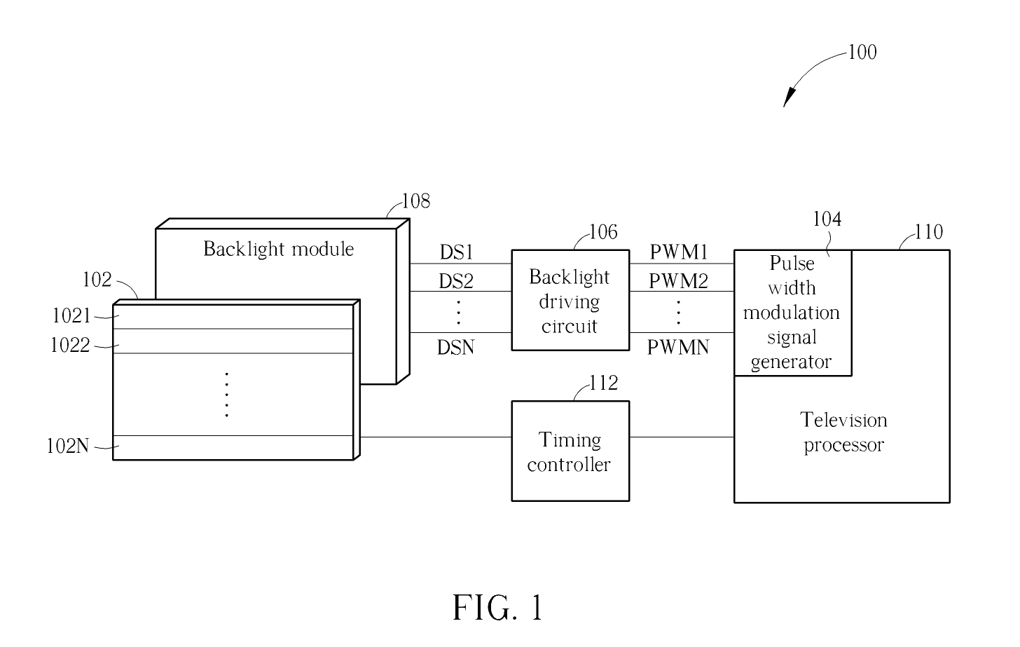

Please refer to FIG. 1. FIG. 1 is a diagram illustrating a liquid crystal display device 100 capable of reducing residual images according to an embodiment. As shown in FIG. 1, the liquid crystal display device 100 includes a liquid crystal panel 102, a pulse width modulation signal generator 104, a backlight driving circuit 106, and a backlight module 108, where the pulse width modulation signal generator 104 is included in a television processor 110. The liquid crystal panel 102 has a 60 Hz frame rate, and the liquid crystal panel 102 includes multiple display blocks 1021-102N, where N is a positive integer. The pulse width modulation signal generator 104 is used for generating multiple pulse width modulation signals PWM1-PWMN corresponding to the display blocks 1021-102N. The backlight driving circuit 106 is used for generating multiple driving signals DS1-DSN corresponding to the display blocks 1021-102N according to the pulse width modulation signals PWM1-PWMN. The backlight module 108 is used for correspondingly providing backlight to the display blocks 1021-102N of the liquid crystal panel 102 according to the driving signals DS1-DSN, where the backlight module 108 can be a light-emitting diode backlight module or a cold cathode fluorescent lamp (CCFL) backlight module. In addition, as shown in FIG. 1, the television processor 110 can synchronously control liquid crystal states of the display blocks 1021-102N through a timing controller 112 according to timings of the pulse width modulation signals PWM1-PWMN.

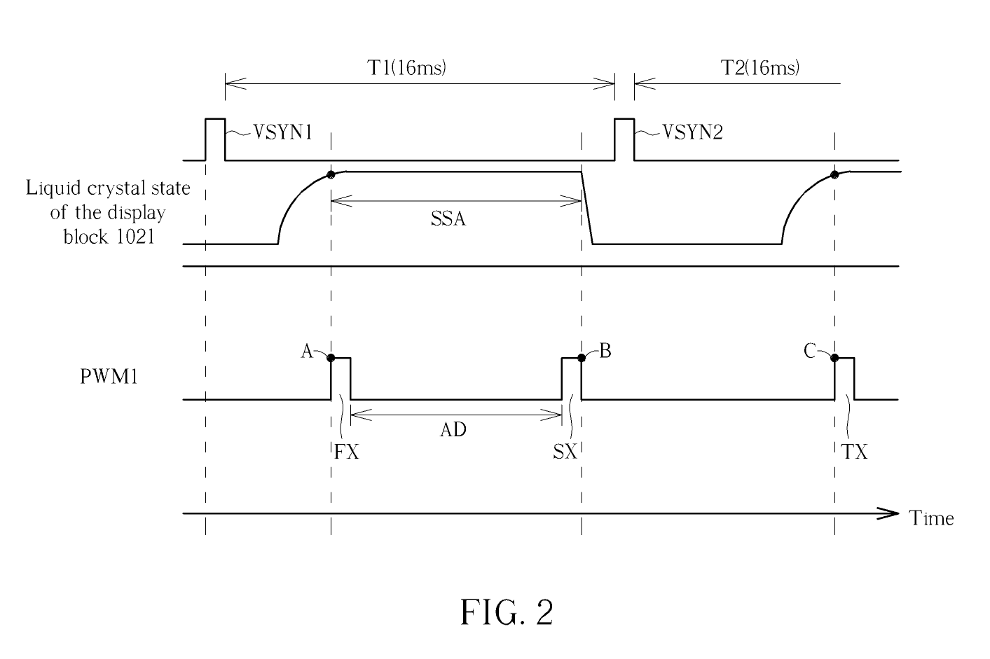

Please refer to FIG. 2. FIG. 2 is a diagram illustrating a frame period T1, a liquid crystal state of the display block 1021, and the pulse width modulation signal PWM1 of the liquid crystal panel 102. As shown in FIG. 2, the pulse width modulation signal PWM1 has a first fixed width pulse voltage FX and a second fixed width pulse voltage SX during the frame period T1 (that is, a period between two consecutive vertical synchronous signals VSYN1, VSYN2) of the liquid crystal panel 102. A period between a beginning A of the first fixed width pulse voltage FX and an end B of the second fixed width pulse voltage SX is longer than or equal to 16 milliseconds (corresponding to the 60 Hz frame rate of the liquid crystal panel 102) minus a predetermined time Y̅, whether the period between the beginning A of the first fixed width pulse voltage FX and the end B of the second fixed width pulse voltage SX is defined as a liquid crystal relative steady-state area SSA of the liquid crystal panel 102. That is to say, a beginning of the liquid crystal relative steady-state area SSA is the beginning A of the first fixed width pulse voltage FX, and an end of the liquid crystal relative steady-state area SSA is the end B of the second fixed width pulse voltage SX. In addition, a period between the end B of the second fixed width pulse voltage SX and a beginning C of a first fixed width pulse voltage TX of a next frame period T2 of the pulse width modulation signal PWM1 is shorter than or equal to the predetermined time Y̅. That is to say, a turning-off period of the backlight module 108 during a liquid crystal non-relative steady-state area of the liquid crystal panel 102 can not be longer than the predetermined time Y̅ to prevent eyes of a user from perceiving flickers. In addition, as shown in FIG. 2, the second fixed width pulse voltage SX exists between the first fixed width pulse voltage FX and the first fixed width pulse voltage TX, where length of the first fixed width pulse voltage FX, length of the second fixed width pulse voltage SX, and length of the first fixed width pulse voltage TX can be the same or different.

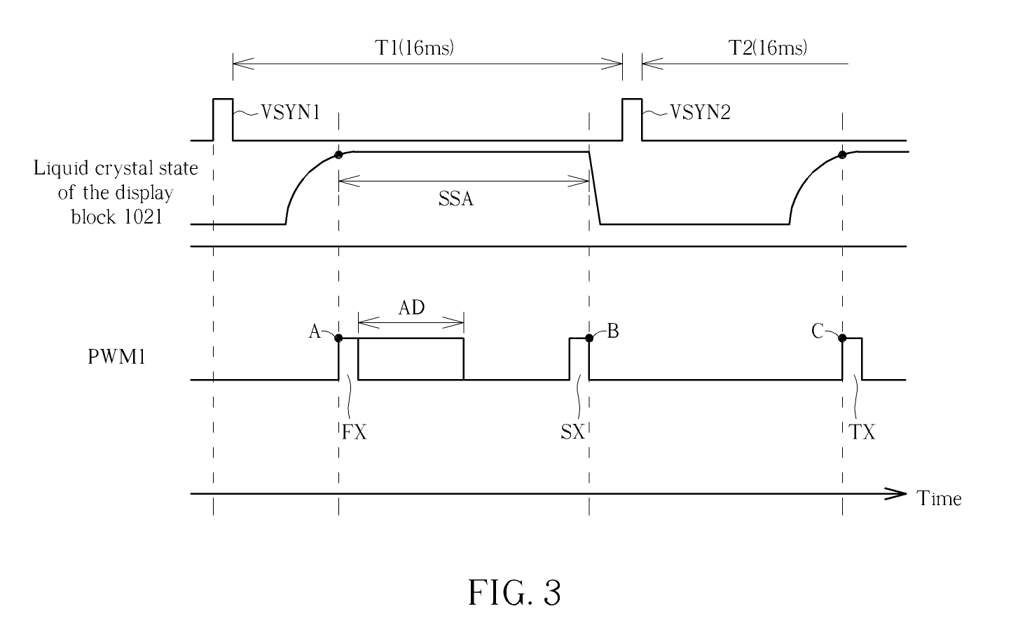

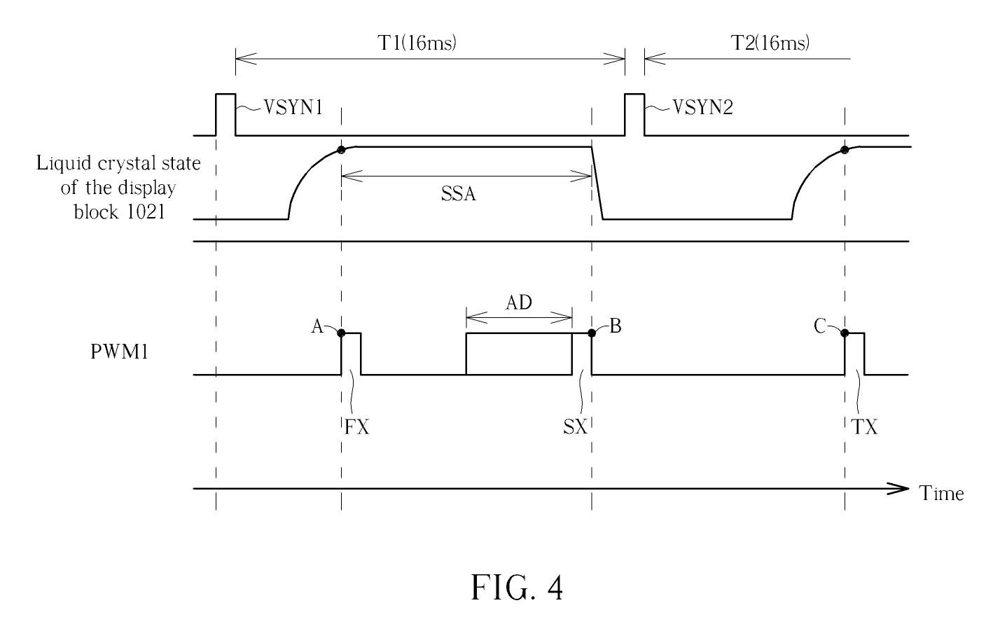

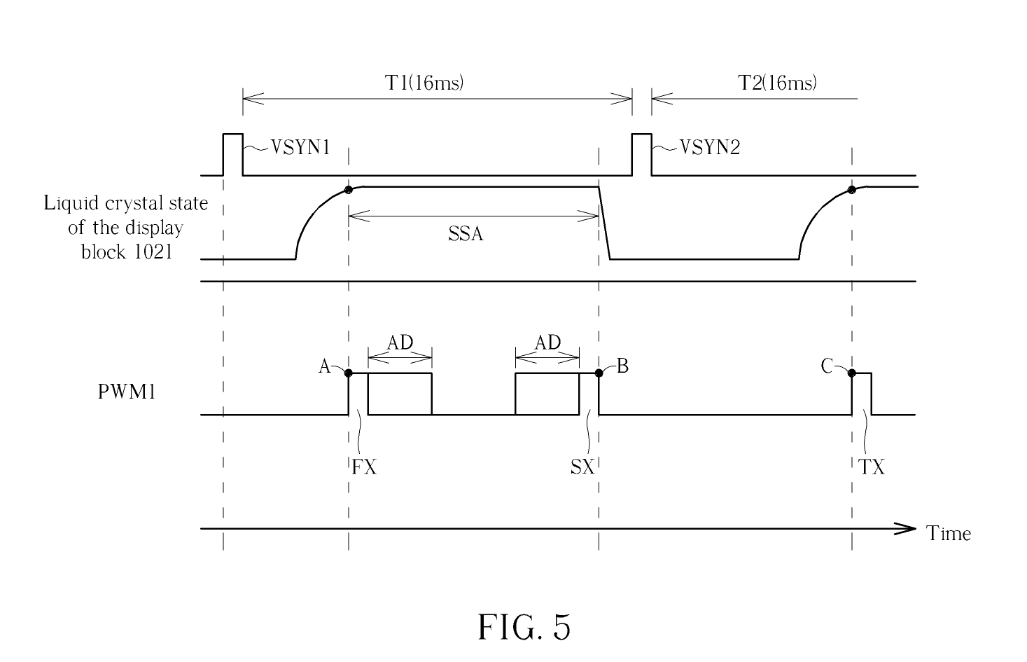

As shown in FIG. 2, a turning-on period of the pulse width modulation signal PWM1 during the liquid crystal relative steady-state area SSA is equal to a sum of a lasting time of the first fixed width pulse voltage FX, a lasting time of the second fixed width pulse voltage SX, and a lasting time of the adjustable width pulse voltage AD. Therefore, the user can adjust backlight luminance provided by the backlight module 108 through the adjustable width pulse voltage AD. That is to say, the backlight luminance provided by the backlight module 108 is changed with length of the adjustable width pulse voltage AD. Please refer to FIG. 3, FIG. 4, and FIG. 5. FIG. 3, FIG. 4, and FIG. 5 are diagrams illustrating the adjustable width pulse voltage AD according to different embodiments. As shown in FIG. 3, FIG. 4, and FIG. 5, the length of adjustable width pulse voltage AD can be changed according to a practical requirement of the user. Because the adjustable width pulse voltage AD is within the liquid crystal relative steady-state area SSA, the user can adjust the backlight luminance provided by the backlight module 108 through the adjustable width pulse voltage AD without making the eyes of the user perceive flickers. In addition, as shown in FIG. 3, FIG. 4, and FIG. 5, the first fixed width pulse voltage FX, the second fixed width pulse voltage SX, and the adjustable width pulse voltage AD are within the liquid crystal relative steady-state area SSA, so a sum of a lasting time of the first fixed width pulse voltage FX, a lasting time of the second fixed width pulse voltage SX, and a lasting time of the adjustable width pulse voltage AD is shorter than or equal to the liquid crystal relative steady-state area SSA. In addition, liquid crystal states of the display blocks 1022-102N and operational principles of the pulse width modulation signals PWM2-PWMN are the same as the liquid crystal state of the display block 1021 and the operational principle of the pulse width modulation signal PWM1, so further description thereof is omitted for simplicity.

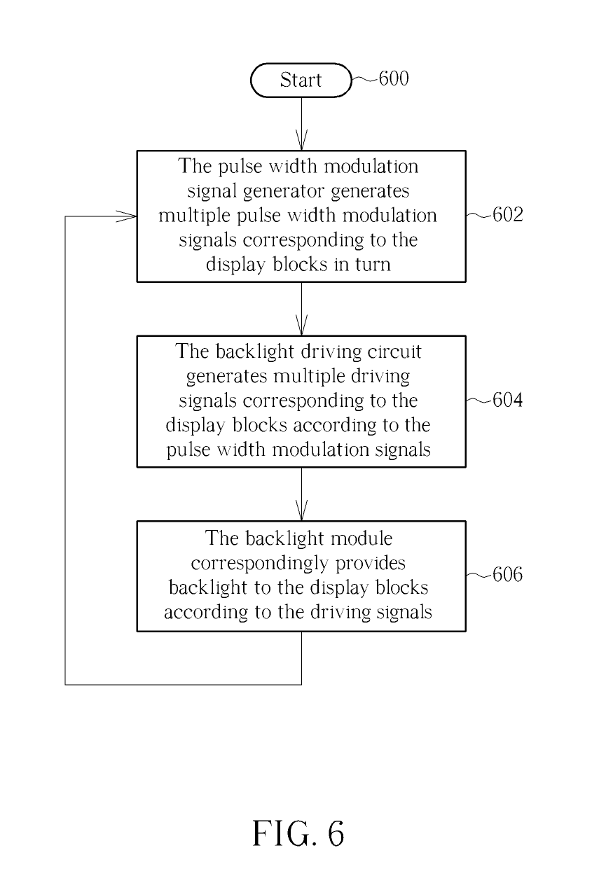

Please refer to FIG. 1, FIG. 2, FIG. 3, FIG. 4, FIG. 5, and FIG. 6. FIG. 6 is a flowchart illustrating a method of reducing residual images of a liquid crystal display device according to another embodiment. The method in FIG. 6 is illustrated using the liquid crystal display device 100 in FIG. 1. Detailed steps are as follows:

Step 600: Start.

Step 602: The pulse width modulation signal generator 104 generates multiple pulse width modulation signals PWM1-PWMN corresponding to the display blocks 1021-102N in turn.

Step 604: The backlight driving circuit 106 generates multiple driving signals DS1-DSN corresponding to the display blocks 1021-102N according to the pulse width modulation signals PWM1-PWMN.

Step 606: The backlight module 108 correspondingly provides backlight to the display blocks 1021-102N according to the driving signals DS1-DSN; go to Step 602.

In Step 602, as shown in FIG. 1, the liquid crystal panel 102 includes the display blocks 1021-102N, and has a 60 Hz frame rate. As shown in FIG. 2, the beginning A of the first fixed width pulse voltage FX and the end B of the second fixed width pulse voltage SX of the pulse width modulation signal PWM1 during the frame period T1 of the liquid crystal panel 102 (that is, the period between the two consecutive vertical synchronous signals VSYN1, VSYN2) is longer than or equal to 16 milliseconds (corresponding to the 60 Hz frame rate of the liquid crystal panel 102) minus the predetermined time Y̅, where the period between the beginning A of the first fixed width pulse voltage FX and the end B of the second fixed width pulse voltage SX is defined as the liquid crystal relative steady-state area SSA of the liquid crystal panel 102. In addition, the period between the end B of the second fixed width pulse voltage SX and the beginning C of the first fixed width pulse voltage TX of the next frame period T2 of the pulse width modulation signal PWM1 is shorter than or equal to the predetermined time Y̅. That is to say, the turning-off period of the backlight module 108 during the liquid crystal non-relative steady-state area of the liquid crystal panel 102 can not be longer than predetermined time Y̅ to prevent the eyes of the user from perceiving flickers. In addition, the length of the first fixed width pulse voltage FX, the length of the second fixed width pulse voltage SX, and the length of the first fixed width pulse voltage TX can be the same or different. As shown in FIG. 2, the turning-on period of the pulse width modulation signal PWM1 during the liquid crystal relative steady-state area SSA is equal to the sum of the lasting time of the first fixed width pulse voltage FX, the lasting time of the second fixed width pulse voltage SX, and the lasting time of the adjustable width pulse voltage AD. Therefore, the user can adjust the backlight luminance provided by the backlight module 108 through the adjustable width pulse voltage AD. That is to say, the backlight luminance provided by the backlight module 108 is changed with the length of the adjustable width pulse voltage AD. In addition, as shown in FIG. 3, FIG. 4, and FIG. 5, the first fixed width pulse voltage FX, the second fixed width pulse voltage SX, and the adjustable width pulse voltage AD are within the liquid crystal relative steady-state area SSA, so the sum of the lasting time of the first fixed width pulse voltage FX, the lasting time of the second fixed width pulse voltage SX, and the lasting time of the adjustable width pulse voltage AD is shorter than or equal to the liquid crystal relative steady-state area SSA. As shown in FIG. 3, FIG. 4, and FIG. 5, the adjustable width pulse voltage AD can be changed according to a practical requirement of the user. Because the adjustable width pulse voltage AD is within the liquid crystal relative steady-state area SSA, the user can adjust the backlight luminance provided by the backlight module 108 through the adjustable width pulse voltage AD, but not make the eyes of the user feel flickers. In addition, the liquid crystal states of the display blocks 1022-102N and the operational principles of the pulse width modulation signals PWM2-PWMN are the same as the liquid crystal state of the display block 1021 and the operational principle of the pulse width modulation signal PWM1, so further description thereof is omitted for simplicity.

To sum up, the liquid crystal display device capable of reducing residual images and the method of reducing residual images of the liquid crystal display device utilize the pulse width modulation signal generator to generate multiple pulse width modulation signals corresponding to the display blocks of the liquid crystal panel, where a liquid crystal relative steady-state area of the liquid crystal panel defined by each pulse width modulation signal between two consecutive vertical synchronous signals of the liquid crystal panel is longer than or equal to 16 milliseconds minus the predetermined time. Therefore, compared to the prior arts, the present invention not only can solve the problem of flickers on the liquid crystal panel and avoid reducing backlight luminance, but also can have lower manufacture cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display device capable of reducing residual images, the liquid crystal display device comprising:
a liquid crystal panel having a 60 Hz frame rate, wherein the liquid crystal panel comprises multiple display blocks;
a pulse width modulation signal generator for generating multiple pulse width modulation signals corresponding to the display blocks in turn, wherein each pulse width modulation signal has a first fixed width pulse voltage and a second fixed width pulse voltage during each frame period of the liquid crystal panel, a period between a beginning of the first fixed width pulse voltage and an end of the second fixed width pulse voltage is longer than or equal to 16 milliseconds minus a predetermined time, wherein a period between the end of the second fixed width pulse voltage and a beginning of a first fixed width pulse voltage of a next frame period is shorter than or equal to the predetermined time;
a backlight driving circuit for generating multiple driving signals corresponding to the display blocks according to the pulse width modulation signals; and
a backlight module for correspondingly providing backlight to the display blocks according to the driving signals.

2. The liquid crystal display device of claim 1, wherein each pulse width modulation signal further has an adjustable width pulse voltage during each frame period of the liquid crystal panel, the adjustable width pulse voltage exists between the first fixed width pulse voltage and the second fixed width pulse voltage, and the adjustable width pulse voltage is followed behind the first fixed width pulse voltage, or the second fixed width pulse voltage is followed behind the adjustable width pulse voltage.

3. The liquid crystal display device of claim 2, wherein a sum of a lasting time of the first fixed width pulse voltage, a lasting time of the second fixed width pulse voltage and a lasting time of the adjustable width pulse voltage is shorter than or equal to the period between the beginning of the first fixed width pulse voltage and the end of the second fixed width pulse voltage.

4. The liquid crystal display device of claim 2, wherein the period between the beginning of the first fixed width pulse voltage and the end of the second fixed width pulse voltage is equal to a sum of a lasting time of the first fixed width pulse voltage, a lasting time of the second fixed width pulse voltage and a lasting time of the adjustable width pulse voltage.

5. The liquid crystal display device of claim 4, wherein the period between the beginning of the first fixed width pulse voltage and the end of the second fixed width pulse voltage is defined as a liquid crystal relative steady-state area of the liquid crystal panel.

6. A method of reducing residual images of a liquid crystal display device, the liquid crystal display device comprising a pulse width modulation signal generator, a backlight driving circuit, a backlight module, and a liquid crystal panel, wherein the liquid crystal panel has a 60 Hz frame rate, and the liquid crystal panel comprises multiple display blocks, the method comprising:
the pulse width modulation signal generator generating multiple pulse width modulation signals corresponding to the multiple display blocks in turn, wherein each pulse width modulation signal has a first fixed width pulse voltage and a second fixed width pulse voltage during each frame period of the liquid crystal panel, a period between a beginning of the first fixed width pulse voltage and an end of the second fixed width pulse voltage is longer than or equal to 16 milliseconds minus a predetermined time, wherein a period between the end of the second fixed width pulse voltage and a beginning of a first fixed width pulse voltage of a next frame period is shorter than or equal to the predetermined time;
the backlight driving circuit generating multiple driving signals corresponding to the display blocks according to the pulse width modulation signals; and
the backlight module correspondingly providing backlight to the display blocks according to the driving signals.

7. The method of claim 6, wherein each pulse width modulation signal further has an adjustable width pulse voltage during each frame period of the liquid crystal panel, the adjustable width pulse voltage exists between the first fixed width pulse voltage and the second fixed width pulse voltage, and the adjustable width pulse voltage is followed behind the first fixed width pulse voltage, or the second fixed width pulse voltage is followed behind the adjustable width pulse voltage.

8. The method of claim 7, wherein a sum of a lasting time of the first fixed width pulse voltage, a lasting time of the second fixed width pulse voltage and a lasting time of the adjustable width pulse voltage is shorter than or equal to the period between the beginning of the first fixed width pulse voltage and the end of the second fixed width pulse voltage.

9. The method of claim 7, wherein the period between the beginning of the first fixed width pulse voltage and the end of the second fixed width pulse voltage is equal to a sum of a lasting time of the first fixed width pulse voltage, a lasting time of the second fixed width pulse voltage and a lasting time of the adjustable width pulse voltage.

10. The method of claim 9, wherein the period between the beginning of the first fixed width pulse voltage and the end of the second fixed width pulse voltage is defined as a liquid crystal relative steady-state area of the liquid crystal panel.
